(19) United States
(12) Patent Application Publication
(10) Pub. No.: US 2012/0218735 A1
(43) Pub. Date: Aug. 30, 2012

(54) MEDICAL LUMINAIRE HAVING A LUMINOPHORE LAYER

(75) Inventors: Michael Wolter, Hamburg (DE); Peter Schouwink, Hamburg (DE); Andreas Mueckner, Schwarzenbek (DE)

(73) Assignee: OLYMPUS WINTER & IBE GMBH, Hamburg (DE)

(21) Appl. No.: 13/393,353

(22) PCT Filed: Aug. 26, 2010
(86) PCT No.: PCT/EP2010/005227

§ 371 Date: May 14, 2012

(30) Foreign Application Priority Data
Sep. 4, 2009 (DE) 10 2009 040 095.8

(51) Int. Cl. F21V 9/16

(52) U.S. Cl. 362/84

(57) ABSTRACT

A medical light for illuminating fluorescent areas. The medical light including: at least one light-emitting diode with at least one luminophore layer for converting short-wave light into broad-band light; and a control device for controlling illumination from the at least one light-emitting diode, wherein the control device controls a ratio between converted and unconverted light and the converted and unconverted light are emitted over a common light guide.

### CROSS-REFERENCE TO RELATED APPLICATION

The present application is based upon and claims the benefit of priority from PCT/EP2010/005227 filed on Aug. 26, 2010, which claims benefit to DE 10 2009 040 095.8 filed on Sep. 4, 2009, the entire contents of each of which are incorporated herein by reference.

### BACKGROUND

1. Field

The present invention generally relates to a medical luminaire, and particularly to a medical luminaire of the type described in claim 1.

2. Prior Art

Medical luminaires for illuminating fluorescent areas are described in DE 19902184 C1 and DE 19639653 A1. With such luminaires, short wave excitation light is shined onto the area to be observed, so that long-wave fluorescent light is generated in fluorescent areas. Using this technique, in particular, it is possible to recognize tumours which were first prepared by administering fluorescent substances. This technique is called photodynamic diagnosis (PDD).

Observation is generally done through a yellow filter to suppress the short-wave excitation light so that the weak fluorescent light is readily visible against a dark background. However, it should be noted that a background light is needed to orient oneself, thus to be able to locally assign the observed fluorescence site in visible light. For this purpose a background light may be added, which insofar as possible should not interfere with the observation of the fluorescent light.

DE 102006011749 A1 discloses a medical luminaire which consists of several light-emitting diodes that produce the primary colors of white light. Thus when all light-emitting diodes are operated together, white light is produced. One of these diodes produces the short-wave excitation light. Thus by simple electrical switching and without mechanical operations such as moving filters in and out of the way, it is possible to switch rapidly between white light and excitation light or to produce a mixture of the two.

DE 102005036147 A1 shows a design of this type which serves to illuminate tissues for observation purposes with broad-band light from an annular light source and for spectroscopic purposes with narrow-band UV light. These two light types are kept strictly separate in construction with the known design, wherein the narrow-band fluorescent light is conveyed through fibres separate from the remaining light path. In addition, in the known design the control device for controlling the illumination is formed as a sequence control, which ensures that the two light types are not emitted together, but are strictly separated in time. Thus mixing of the two light types is not possible and it is therefore not possible also to generate a background light during the observation of fluorescent areas.

### SUMMARY

The goal of the present invention consists of making light mixtures possible in a design of the class described.

The invention uses the known method for generating white light by means of a light-emitting diode generating short-wave light, wherein white light is produced from this light by transformation in a luminophore layer. The invention uses such a light-emitting layer and such a luminophore layer separately and under control with a control device, so that the relationship between non-converted short-wave light and converted broad-band light can be controlled. Thus for use in PDD, it is possible to switch in a very simple way between short-wave excitation light and broad-band background light or to control the ratio between these two types of light. In the case of broad-band light generated by transformation with a luminophore layer, a very good color reproduction index is obtained. The two light types use a common light guide and are shined by these onto the region to be observed. Thus if both light types are turned on simultaneously, the entire area to be observed can be irradiated with mixed light. During the observation of fluorescent areas, the other areas illuminated by the background light are also recognizable, so that the orientation and overview is retained for the eye and the recognized fluorescent areas can be placed within the background geometry.

In an advantageous embodiment according to claim 2, such a luminaire uses a light-emitting diode with a luminophore layer and a light-emitting diode without a luminophore layer and controls these two light-emitting diodes. The mixed light from these two light-emitting diodes can be switched back and forth as desired between pure short-wave light and white light or continuously between these extremes.

As an alternative to this, the features of claim 3 are advantageously provided. Here, the luminophore layer is modified to change the light. This can be done for example by adjustment of the distance, blocking off or the like.

Advantageously according to claim 4 the luminophore layer is designed as a movable wedge, which can be moved in the manner of a gray wedge for different degrees of conversion of the light.

The luminophore layer can be advantageously arranged on a rotary-controlled wheel according to claim 5.

### BRIEF DESCRIPTION OF THE DRAWINGS

In the drawing the invention is shown schematically by way of example, in which:

FIG. 1 illustrates a highly schematized side view of the medical luminaire in a first embodiment,

FIG. 2 illustrates a section along line 2-2 in FIG. 1,

FIG. 3 illustrates, in a section corresponding to FIG. 1, a different embodiment of the luminaire according to the invention,

FIG. 4 illustrates, in the same sectional view, an additional embodiment of the invention, and

FIG. 5 illustrates a section along line 5-5 in FIG. 4.

### DETAILED DESCRIPTION

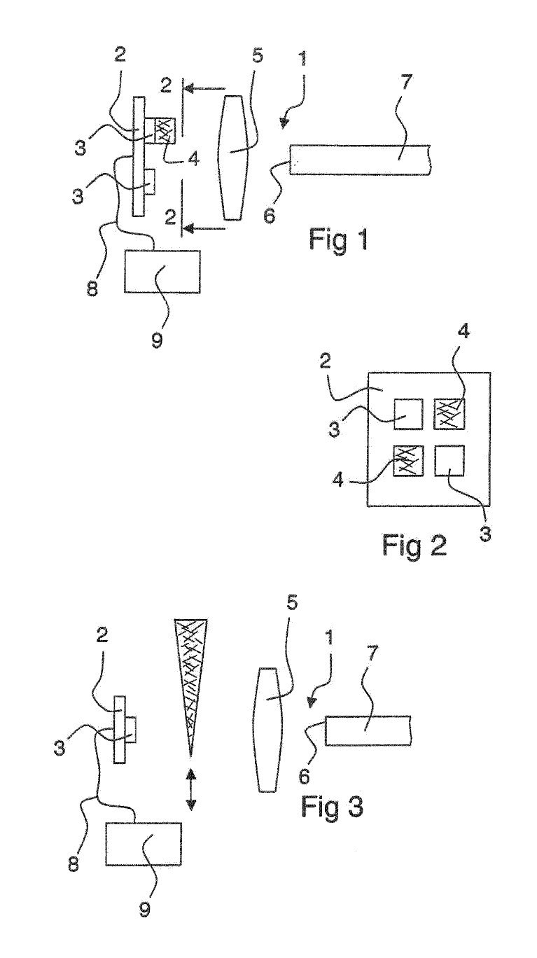

FIGS. 1 and 2 show a medical luminaire with which short excitation light and broad-band background light are to be generated to illuminate fluorescent areas for the PDD process. For this purpose the luminaire 1 on a support plate 2 has a total of four light-emitting diodes 3, two of which are covered with a luminophore layer 4. All four light-emitting diodes emit light through a condenser 5, which is shown highly schematically in the form of a lens, onto the front surface 6 of a fibre light guide 7, with which the light is transported to a location to be illuminated, not shown. The fibre light guide 7 for example is disposed in an endoscope, through which the area to be illuminated is viewed. Details regarding this can be seen in the documents cited initially.

Avoiding the use of a condenser, the light-emitting diodes can also be arranged directly on the front 6 of the fibre light guide 7 or on the front face of a fibre cone arranged on the front face 6.

The four light-emitting diodes shown are connected with a supply or control conduit 8 to a control device 9, with which the brightness of the four light-emitting diodes can be controlled individually.

The two light-emitting diodes provided with a luminophore layer 4 generate broad-band light, e.g., white light. The illuminated diode without a luminophore layer generates short-wave blue or violet light, which is suitable for the excitation of fluorescence and is tuned to the fluorescent substances used for tumour marking in PDD. By means of the control device 9, the ratio between the non-converted short-wave light generated directly by naked light-emitting diodes and the broad-band light converted by a luminophore layer 4 can be adjusted as desired, or can also be switched between the light types.

FIG. 3 shows a second embodiment of the invention in which the same reference symbols are used insofar as possible. In this case, only one light-emitting diode 3 is assigned to the support plate 2, specifically without a luminophore layer. Between the light-emitting diode 3 and the condenser, or the subsequently connected fibre light guide 7, a luminophore layer in the form of a wedge 10 is arranged, which can be moved in the direction of the arrow. The wedge 10 forms a luminophore layer of variable thickness. By moving it in the direction of the arrow, the thickness of the luminophore layer penetrated by the light of the light-emitting diode can be modified, so that more or less large fractions of the short-wave light generated by the light-emitting diode 3 can be converted into broad-band light. The position of the wedge 10 can be adjusted as needed with the control device 9, not shown.

The wedge 10, as shown, may be of varying thickness, or for example may also be designed as a layer of constant thickness in which only the concentration of the luminophore varies.

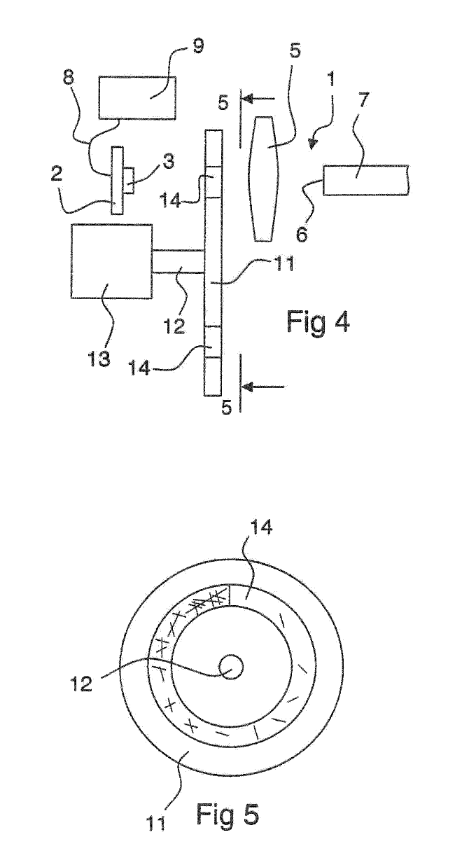

A variant of this embodiment is shown in FIG. 4. Instead of the wedge 10, here a wheel 11 is provided, which is operated over a shaft 12 by a motor 13, which is controlled by the control device 9, not shown. Thus the rotary position of the wheel 11 can be modified while viewing with the control device. The wheel is shown in FIG. 5. A luminophore ring 14 can be seen, which as indicated in FIG. 5 contains luminophore in a variable thickness and for example can be designed as a layer of variable thickness similar to the wedge 10. The converting strength of the luminophore can be adjusted by rotating the wheel 11.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

1. A medical light for illuminating fluorescent areas, the medical light comprising:
at least one light-emitting diode with at least one luminophore layer for converting short-wave light into broad-band light; and
a control device for controlling illumination from the at least one light-emitting diode,
wherein the control device controls a ratio between converted and unconverted light and the converted and unconverted light are emitted over a common light guide.

2. The medical light according to claim 1, wherein the at least one light-emitting diode with at least one luminophore layer comprises at least one light-emitting diode with at least one luminophore layer and at least one light-emitting diode without a luminophore layer.

3. The medical light according to claim 1, wherein the at least one luminophore layer has a variable thickness, controllable by the control device.

4. The medical light according to claim 3, wherein the at least one luminophore layer having the variable thickness is constructed as a wedge.

5. The medical light according to claim 3, wherein the at least one luminophore layer is arranged around a rotation-controlled wheel.
